(19) United States
(12) Patent Application Publication
(10) Pub. No.: US 2013/0110301 A1
(43) Pub. Date: May 2, 2013

(54) ENERGY-AWARE COMPUTING SYSTEM

(71) Applicants: Hoffmann Martin, Heidelberg (DE); Thormaehien Fredderik, Mannheim (DE)

(72) Inventors: Hoffmann Martin, Heidelberg (DE); Thormaehien Fredderik, Mannheim (DE)

(73) Assignee: SAP AG, Walldorf (DE)

(21) Appl. No.: 13/281,670

(22) Filed: Oct. 26, 2011

(51) Int. Cl. G06F 1/32

(52) U.S. Cl. 700/295

(57) ABSTRACT

An apparatus, method and computer-readable storage medium for a centralized mechanism in systems and processes (both local and remote) to efficiently view and control energy consumption and pollution production of various systems. A central profile menu may display multiple profiles to a user. These profiles may include energy saving profiles and/or pollution reduction profiles. The user may select a particular profile from the list of profiles, resulting in one or more messages which conform to an application programming interface (API) being sent to one or more applications. The one or more messages may include parameters corresponding to the selected profile. In response to the messages, the receiving applications may change one or more application settings which affect energy consumption or pollution production of one or more systems controlled by the applications.

### BACKGROUND

In recent years, ecological resources available for power generation have become more scarce, while global power consumption has increased. According to a Stanford University study, the total electricity required for data centers doubled worldwide between 2000 and 2005. According to an analysis by McKinsey & Company, energy demand is expected to double yet again by 2020 to power the world's computers, data storage, and communications network. This has led to much higher prices for energy, which impacts both private households and large companies. In addition to energy prices, nations are affected by emissions trading such as the European Union Emissions Trading Scheme which incentivize countries to minimize resources which pollute the environment.

Despite the need to reduce energy consumption and pollution, private households and companies are unable to easily do so because individuals are not aware of the impact their actions have on energy consumption and pollution. Consequently, individuals are also unaware of the associated monetary costs, not only from an individual's perspective, but also from the environment's perspective. For example, currently on laptop computers, a user cannot see how much it costs her to enable certain services and applications (like polling for emails each 5 minutes, Bluetooth) before the user enables them. Since a majority of applications today are client/server applications, the server side also needs to be taken into account, especially considering that for many applications the resources consumed on the server are much higher than on the client.

Additionally, individuals lack a central interface from which to control their energy consumption. For example, if a computer user wants to decrease his energy consumption on a client computer, he can only do so via different operating system settings affecting the hardware level such as switching off Wifi, throttling the CPU speed, and adjusting the screen brightness. In some applications there are settings which also have an effect on the power consumption, e.g. the polling interval in mail clients or the possibility to disable the flash plug-in of the web browser. However, there is no single point in the system where the user can specify that he wants to save energy, such that individual applications use a reasonable strategy to save energy while not compromising too much of their functionality (switching off Wifi on operating system level for a mobile device renders it rather useless, while adjusting the polling interval of the mail application from 1 minute to 30 minutes is reasonable). Similarly, the user cannot influence whether the server side of an application should treat resources with care (ecological resources as well as monetary); there might be some settings which indirectly influence the resource consumption on the server as well (e.g. number of search results shown on a web site), but this also has to be configured for each application instead of using a central setting in the client computer.

Thus, there is a need for a centralized mechanism in systems and processes to efficiently view and control energy consumption and pollution production of various systems.

### BRIEF DESCRIPTION OF THE DRAWINGS

FIG. 1 shows an exemplary central profile menu from which a user may choose different energy profiles in an embodiment of the invention.

FIG. 2 shows an exemplary application menu illustrating a notification in an embodiment of the invention.

FIG. 3 shows an exemplary application menu without any notifications in an embodiment of the invention.

FIG. 4 shows an exemplary central profile menu with notifications about the cost savings and corresponding performance in an embodiment of the invention.

FIG. 5 shows an exemplary architecture in an embodiment of the invention.

### DETAILED DESCRIPTION

Embodiments may be discussed herein that present a centralized mechanism in systems and processes to efficiently view and control energy consumption and pollution production of various systems. In particular, embodiments of the present invention pertain to a feature for presenting a central profile menu in a user interface on a device. The central profile menu may display multiple profiles to a user. These profiles may include energy saving profiles and/or pollution reduction profiles. In addition to the profiles, notifications associated with the profiles may be displayed on the user interface. The notifications may describe an amount of energy consumed, an amount of energy saved, an amount of money spent, an amount of money saved, an amount of pollution output, or an amount of pollution reduced. The notifications may be derived from statistics generated from historical usage or real-time variables associated with various applications and systems. The user may select a particular profile from the list of profiles, resulting in one or more messages which conform to an application programming interface (API) being sent to one or more applications. The applications may include computer software applications, web applications, computer server applications, software applications integrated into automobiles, and software applications integrated into households. The one or more messages may include parameters corresponding to the selected profile. In response to the messages, the applications may change one or more application settings which affect energy consumption or pollution production of one or more systems controlled by the applications. The systems may include computers, computer servers, mobile phones, automobiles, and households.

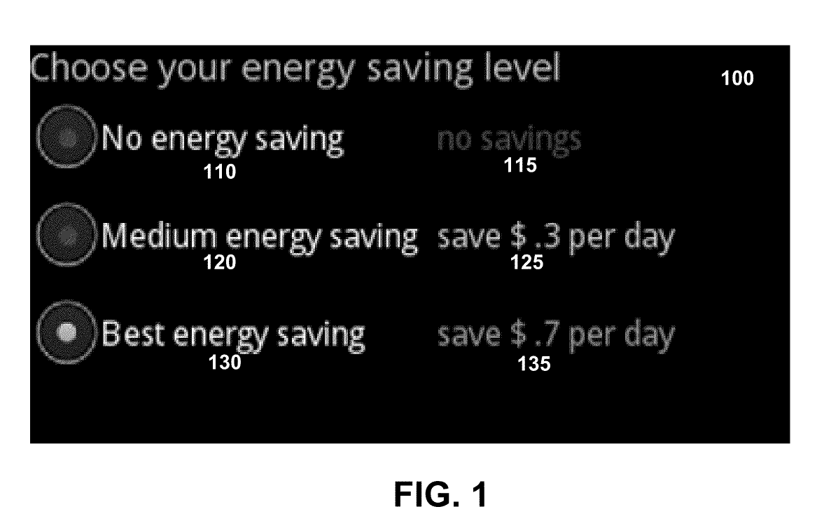

FIG. 1 shows a central profile menu 100 displaying three different energy saving profiles to a user via a user interface. The menu 100 is an exemplary menu and is not intended to limit the scope of the disclosed embodiment. The first profile 110 is accompanied by a notification 115 which informs the user that if the first profile 110 is chosen, there will be no energy savings. The second profile 120 is accompanied by a notification 125 which informs the user that if the second profile 120 is chosen, the amount of energy saved will amount to about 0.3 dollars a day. The third profile 130 is accompanied by a notification 135 which informs the user that if the third profile 130 is chosen, the amount of energy saved will amount to about 0.7 dollars a day.

In an embodiment, the central profile menu may display pollution reduction profiles and associated notifications. For example, the menu may display the amount of carbon dioxide released into the environment, or the cost associated with the amount of carbon dioxide released into the environment if a particular pollution reduction profile was selected by the user. One of the benefits of the notifications is that the user is able to view the estimated pollution level or energy consumption level prior to choosing an appropriate profile.

The central profile menu may be displayed in a GUI on any system which consumes energy or outputs pollution. For example, the central profile menu may be displayed in a GUI of a computer, a mobile phone, a vehicle dashboard, a vehicle navigation system, or any display device attached to appliances in a household.

In an embodiment, when a user selects a profile from a central profile menu, a message is sent via an application programming interface (API) to various applications. For example, in an embodiment, a user may select an energy profile in a central profile menu in a laptop, and in response, the operating system on the laptop may send messages conforming to an API to the applications running on the laptop. The applications on the laptop may implement a special callback method, which is called by the operating system when the energy profile is changed by the user. The callback method may have the following signature: changeEnergySettings (Integer energyLevel), where the parameter energyLevel may indicate whether or not energy should be saved and if so, how much energy should be saved (there might be different levels of energy saving, as it is mostly a tradeoff between energy saving and features/performance). For applications started after the energy setting is changed, the energy level may be passed to the application at start time, for example, via command line parameter.

In an embodiment, based on the message sent by the operating system, the applications running on the laptop may adjust their corresponding settings to consume more or less energy. The actions taken by a particular application in response to the message may be implemented by the application developer. For example, an e-mail application on the laptop, in response to a message from the operating system instructing a decrease in energy consumption, may increase the polling interval to check e-mails on a server. If the user had changed some of the energy-related parameters inside the e-mail application prior to receipt of the message from the operating system, these parameters may be overridden in response to the message from the operating system.

In an embodiment, multiple applications may adjust their behavior based on messages sent by the operating system. For example, in an embodiment, video games and other graphics intensive applications may adjust the frame rate, screen resolution, and animation details. Web browsers may enable/disable images and enable/disable flash animations. Business applications may pre-fetch data on the client side. Web applications (client or server side) may adjust the number of results shown per page. Word processors such as Microsoft Word or WordPerfect may disable spell checking while typing.

In an embodiment, a server or a server application may receive a message to adjust its energy level. The message may be sent from an application or operating system on a client computer. Since multiple users may be connected to the server or server application, only the settings on the server side pertaining to the client application or operating system sending the message may be adjusted in response to the message, so that other clients connected to the server are not affected.

The functionality above may be adapted to conserve energy or reduce pollution on any system attached to a display device. For example, in an embodiment, a central profile menu may be presented to the user on a display device in a vehicle such as the vehicle's central console. When a user selects a profile, messages are sent via the API to applications which control the functionality of the vehicle. In response to the messages, the air conditioner may be turned off or the temperature setting of the air conditioner may be adjusted; the windshield wiper, if currently operating, may be set to operate at a different time interval; the lights, if set to high beam, may be set to low beam; heated seats may be turned off; audio speakers may be turned off or set to a different volume; four-wheel drive may be set to two-wheel drive; and the speed or acceleration of the vehicle may be adjusted. The foregoing list of functionalities of the vehicle which may be altered are not exhaustive and are not intended to limit the scope of the disclosed embodiment.

In an embodiment, a central profile menu may be presented to the user on a display device attached to appliances in a household, or attached to a central computer in the household which controls multiple appliances. When a user selects a profile, messages are sent via the API to applications which control the functionality of the applications in the household. In response to the messages, a combination of the household appliances may be turned off; the temperature setting of the air conditioner may be adjusted; the lights may be dimmed; the temperature of water may be adjusted; electric garage doors may be set to manual mode; the amount of water used for flushing toilet bowls may be adjusted; the amount of water used for washing machines and dishwashers may be adjusted; the dishwasher may be set to air dry dishes after washing; audio and video devices may be set to a different volume and/or brightness; and the electricity supplied to recharging appliances (such as a laptop connected to an outlet) may be cut off once the appliance is fully charged. The foregoing list of functionalities of the household appliances which may be altered are not exhaustive and are not intended to limit the scope of the disclosed embodiment.

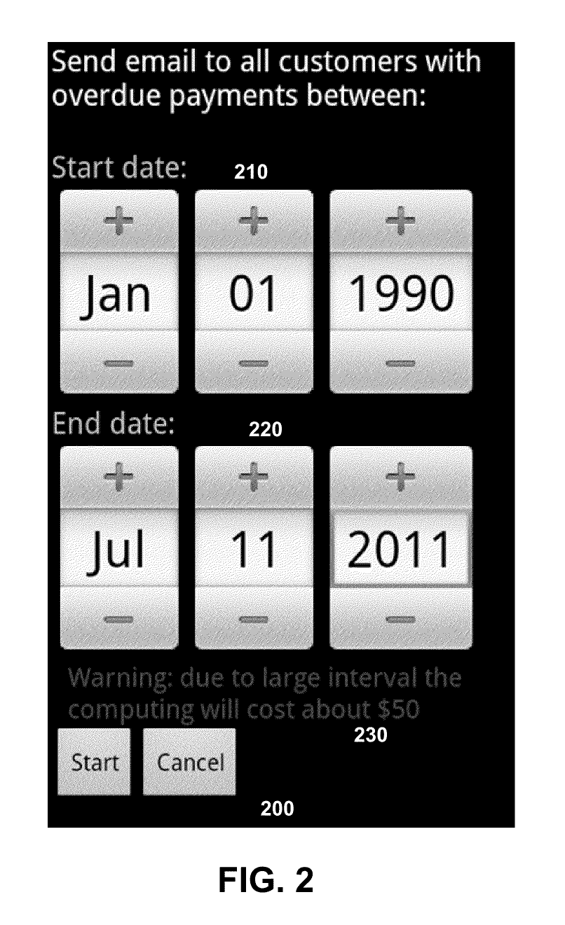

FIG. 2 shows an application menu 200 in an embodiment of the invention. The application menu 200 is an exemplary menu and is not intended to limit the scope of the disclosed embodiment. The application menu 200 allows the user to send out e-mails to customers with overdue payments within a particular time period. If the time period is set to a relatively long period of time, for example from Jan. 1, 1990 and Jul. 11, 2011 (as seen in 210 and 220 respectively), the application menu displays a warning notification 230 stating that due to the large interval the computing cost to send out the e-mails will be about 50 dollars. Based on this warning notification, the user may revise the time period via the application menu.

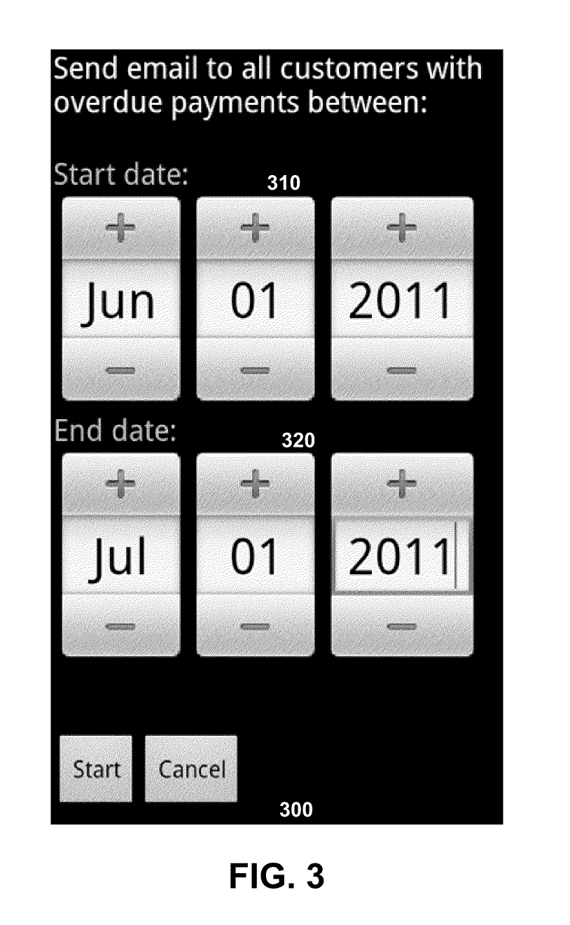

FIG. 3 shows an application menu 300 in an embodiment of the invention where a warning notification is not displayed. The application menu 300 is an exemplary menu and is not intended to limit the scope of the disclosed embodiment. As explained above in FIG. 2, the application menu 300 allows the user to send out e-mails to customers with overdue payments within a particular time period. If the user selects a time period (310, 320) which will be costly from an energy/resources consumption perspective, a warning notification is displayed. However, if the user selects or revises time period so that the operation if executed will not consume too much energy, the warning notification is not displayed.

In an embodiment, notifications from the central profile menu or application menu informing the user about energy consumption details, monetary details, or pollution details may be derived from statistics generated from historical usage of applications or the system. For example, in an embodiment, the user may use a client application to run a search query on a database existing on a server. The database server may store various statistics pertaining to the performance and resource utilization of the database based on queries run on the database in the past. In response to a query drafted by the user, the database server may estimate the amount of energy needed to run the query and send this information to the client application, which is displayed as a notification prior to execution of the query. In an embodiment, the database server may include additional information which suggests changes to the query so that the query consumes less energy. In an embodiment, the database server may have saved the results of the same query run previously, and may present the user with the option to have the previous query results returned instead of running the query again. In an embodiment, the database server may notify the user of the energy saved or pollution reduced by returning the existing results from the previous query.

In an embodiment, notifications from the central profile menu or application menu may be derived from real-time variables related to applications or the system. For example, in an embodiment, a central profile menu may be presented to the user on a display device in a vehicle such as the vehicle's central console. The central profile menu may display different energy saving profiles along with associated monetary cost notifications for the profiles. In order to derive the notifications associated with the profiles, the operating system of the central console may communicate with applications monitoring real-time variables affecting energy consumption of vehicle such as the current temperature outside the vehicle which may be necessary for computing the energy consumption of the air conditioner in the vehicle, the current acceleration of the vehicle which may be necessary to compute the rate of fuel consumed by the vehicle, and the current noise level outside the vehicle which may determine automatic speaker volume adjustments made to the sound system of the vehicle. Based on these real-time variables, the central profile menu may display monetary cost notifications for the profiles on the central profile menu. Accordingly, the user may select a profile from the menu.

In an embodiment, notifications may be generated based on a combination of historical usage statistics and real-time variables. For example, in an embodiment, a central profile menu may be presented to the user on a desktop computer. The central profile menu may display different energy saving profiles along with associated monetary cost notifications for the profiles. In order to derive the notifications associated with the profiles, the operating system of the computer may communicate with applications running on the computer via an API. The running applications may include a graphics intensive application such as a video game application. The video game application may include statistical energy consumption data based on historical usage of the video game application on that particular computer. This data may include the energy consumed when the video game application was run at different settings such as different frame rates, screen resolutions, 3D rendering settings, and animation settings. The video game application may also include real-time variables affecting energy consumption such as current network speeds, and the current frequency of dropped network connections, when connecting to a gaming network. A combination of the historical usage statistics and real-time variables may be transmitted by the video game application to the operating system. Based on this data and a combination of similar data from other applications on the computer, the central profile menu may display monetary cost notifications for the profiles on the central profile menu. Accordingly, the user may select a profile from the menu.

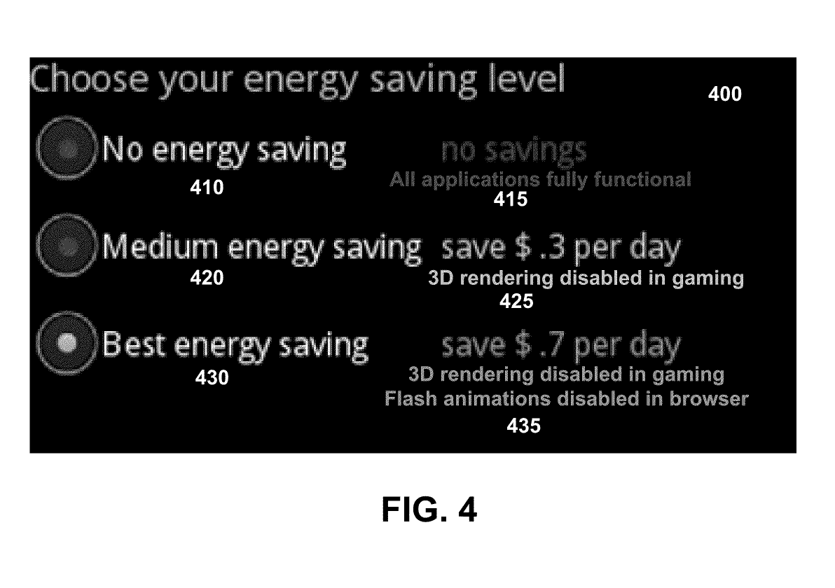

FIG. 4 shows a central profile menu 400 displaying three different energy saving profiles with corresponding notifications. The menu 400 is an exemplary menu and is not intended to limit the scope of the disclosed embodiment. The central profile menu 400 may be presented to the user on a desktop computer. The central profile menu may display different energy saving profiles (410, 420, 430) along with associated notifications (415, 425, 435) for the profiles. In addition to displaying the cost savings associated with each profile as explained in FIG. 1, the central profile menu 400 may display the functionality associated with each profile. For example, if the best energy saving profile 430 is chosen, the system may disable 3D rendering in gaming applications, and flash animations in browser applications 435. Accordingly, the user may select a profile from the menu 400.

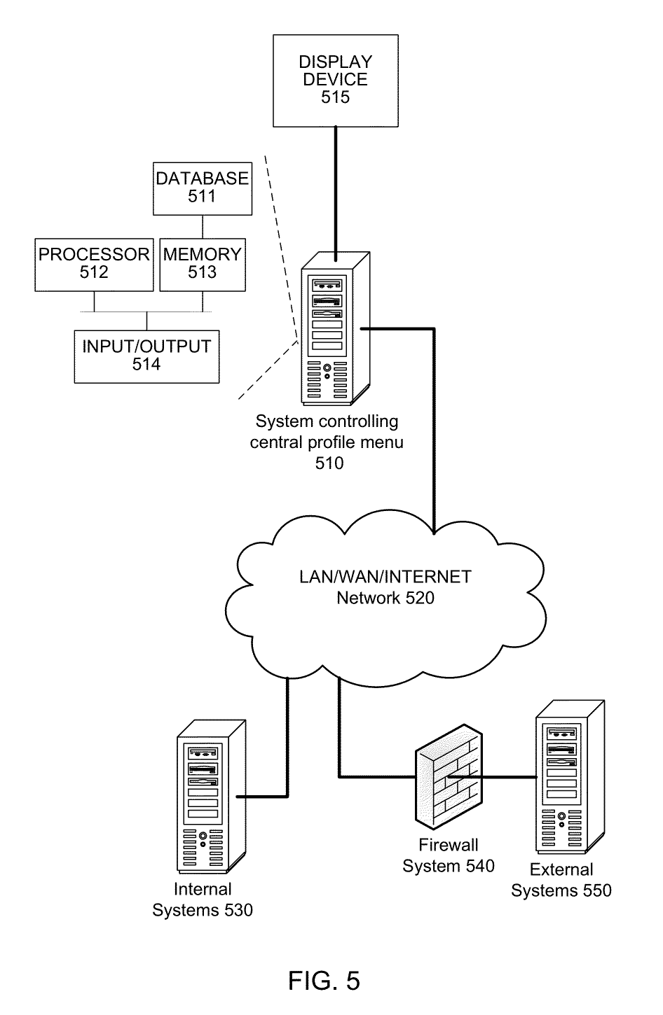

FIG. 5 shows an exemplary architecture in an embodiment of the invention. The system controlling the central profile menu 510 may be coupled to a display device 515, existing internal systems 530 through a network 520 and to external systems 550 through the network 520 and firewall system 540. The system controlling the central profile menu may include a desktop computer, laptop computer, tablet PC, client computer, mobile phone, central computer in a vehicle, computer in a household controlling home appliances, and any other computer. The display device 515 may include a computer monitor, a tablet PC screen, a mobile phone screen, a vehicle's central console screen, a display attached to a computer in a household controlling home appliances, and any other displays. The existing internal systems 530 may include a server and may provide one or more of historical energy consumption data, historical pollution production data, real-time energy consumption data, real-time pollution production data, and other data. The external systems 550 may include a server and may be maintained by a third party, such as a newspaper, information service provider, or exchange, and may contain energy pricing information or pollution cost information, that may be updated by the third party on a periodic basis. The system controlling the central profile menu 510 may interact with these external systems to obtain pricing updates through a firewall system 540 separating the internal systems from the external systems.

Each of the systems in FIG. 5 may contain a processing device 512, memory 513, a database 511, and an input/output interface 514, all of which may be interconnected via a system bus. In various embodiments, each of the systems 510, 530, 540, and 550 may have an architecture with modular hardware and/or software systems that include additional and/or different systems communicating through one or more networks. The modular design may enable a business to add, exchange, and upgrade systems, including using systems from different vendors in some embodiments. Because of the highly customized nature of these systems, different embodiments may have different types, quantities, and configurations of systems depending on the environment and organizational demands.

In an embodiment, memory 513 may contain different components for retrieving, presenting, changing, and saving data. Memory 513 may include a variety of memory devices, for example, Dynamic Random Access Memory (DRAM), Static RAM (SRAM), flash memory, cache memory, and other memory devices. Additionally, for example, memory 513 and processing device(s) 512 may be distributed across several different computers that collectively comprise a system.

Database 511 may include any type of data storage adapted to searching and retrieval. The database 511 may include SAP database (SAP DB), Informix, Oracle, DB2, Sybase, and other such database systems.

Processing device 512 may perform computation and control functions of a system and comprises a suitable central processing unit (CPU). Processing device 512 may comprise a single integrated circuit, such as a microprocessing device, or may comprise any suitable number of integrated circuit devices and/or circuit boards working in cooperation to accomplish the functions of a processing device. Processing device 512 may execute computer programs, such as object-oriented computer programs, within memory 513.

The foregoing description has been presented for purposes of illustration and description. It is not exhaustive and does not limit embodiments of the invention to the precise forms disclosed. Modifications and variations are possible in light of the above teachings or may be acquired from the practicing embodiments consistent with the invention. For example, some of the described embodiments may include software and hardware, but some systems and methods consistent with the present invention may be implemented in software or hardware alone. Additionally, although aspects of the present invention are described as being stored in memory, this may include other computer readable media, such as secondary storage devices, for example, solid state drives, or DVD ROM; the Internet or other propagation medium; or other forms of RAM or ROM.

We claim:

1. A method comprising:
presenting a central profile menu in a user interface on a device, the central profile menu displaying a plurality of profiles to a user, wherein the profiles include at least one of energy saving profiles and pollution reduction profiles;
sending, in response to an input selecting a profile from the plurality of profiles, at least one message via an application programming interface (API) to at least one application, the at least one message including parameters corresponding to the selected profile;
changing, in response to the at least one message, at least one application setting of the at least one application based on the parameters included in the at least one message, wherein the at least one application setting affects at least one of energy consumption and pollution production of at least one system controlled by the at least one application.

2. The method of claim 1, further comprising:
displaying at least one notification on the user interface, wherein the at least one notification is associated with at least one profile from the plurality of profiles, and the at least one notification includes a description of at least one of an amount of energy consumed, an amount of energy saved, an amount of money spent, an amount of money saved, an amount of pollution output, and an amount of pollution reduced.

3. The method of claim 1, wherein the at least one application includes computer software applications, web applications, computer server applications, software applications integrated into automobiles, and software applications integrated into households.

4. The method of claim 1, wherein the at least one system includes computers, computer servers, mobile phones, automobiles, and households.

5. The method of claim 2, wherein the at least one of an amount of energy consumed, an amount of energy saved, an amount of money spent, an amount of money saved, an amount of pollution output, and an amount of pollution reduced is calculated from statistics generated from historical usage of the at least one application and the at least one system.

6. The method of claim 2, wherein the at least one of an amount of energy consumed, an amount of energy saved, an amount of money spent, an amount of money saved, an amount of pollution output, and an amount of pollution reduced is calculated from real-time variables associated with the at least one application and the at least one system.

7. A non-transitory computer-readable medium embodied with computer-executable instructions for causing a computer to execute instructions, the computer instructions comprising:
presenting a central profile menu in a user interface on a device, the central profile menu displaying a plurality of profiles to a user, wherein the profiles include at least one of energy saving profiles and pollution reduction profiles;
sending, in response to an input selecting a profile from the plurality of profiles, at least one message via an application programming interface (API) to at least one application, the at least one message including parameters corresponding to the selected profile;
changing, in response to the at least one message, at least one application setting of the at least one application based on the parameters included in the at least one message, wherein the at least one application setting affects at least one of energy consumption and pollution production of at least one system controlled by the at least one application.

8. The non-transitory computer-readable medium of claim 7, wherein the computer instructions further comprise:
displaying at least one notification on the user interface, wherein the at least one notification is associated with at least one profile from the plurality of profiles, and the at least one notification includes a description of at least one of an amount of energy consumed, an amount of energy saved, an amount of money spent, an amount of money saved, an amount of pollution output, and an amount of pollution reduced.

9. The non-transitory computer-readable medium of claim 7, wherein the at least one application includes computer software applications, web applications, computer server applications, software applications integrated into automobiles, and software applications integrated into households.

10. The non-transitory computer-readable medium of claim 7, wherein the at least one system includes computers, computer servers, mobile phones, automobiles, and households.

11. The non-transitory computer-readable medium of claim 8, wherein the at least one of an amount of energy consumed, an amount of energy saved, an amount of money spent, an amount of money saved, an amount of pollution output, and an amount of pollution reduced is calculated from statistics generated from historical usage of the at least one application and the at least one system.

12. The non-transitory computer-readable medium of claim 8, wherein the at least one of an amount of energy consumed, an amount of energy saved, an amount of money spent, an amount of money saved, an amount of pollution output, and an amount of pollution reduced is calculated from real-time variables associated with the at least one application and the at least one system.

13. An apparatus comprising:
a display device for displaying a user interface;
a data storage for storing data;
a processor for executing computer instructions, the computer instructions comprising:
presenting a central profile menu in the user interface on the display device, the central profile menu displaying a plurality of profiles to a user, wherein the profiles include at least one of energy saving profiles and pollution reduction profiles;
sending, in response to an input selecting a profile from the plurality of profiles, at least one message via an application programming interface (API) to at least one application, the at least one message including parameters corresponding to the selected profile;
changing, in response to the at least one message, at least one application setting of the at least one application based on the parameters included in the at least one message, wherein the at least one application setting affects at least one of energy consumption and pollution production of at least one system controlled by the at least one application.

14. The apparatus of claim 13, wherein the computer instructions further comprise:
displaying at least one notification on the user interface, wherein the at least one notification is associated with at least one profile from the plurality of profiles, and the at least one notification includes a description of at least one of an amount of energy consumed, an amount of energy saved, an amount of money spent, an amount of money saved, an amount of pollution output, and an amount of pollution reduced.

15. The apparatus of claim 13, wherein the at least one application includes computer software applications, web applications, computer server applications, software applications integrated into automobiles, and software applications integrated into households.

16. The apparatus of claim 13, wherein the at least one system includes computers, computer servers, mobile phones, automobiles, and households.

17. The apparatus of claim 14, wherein the at least one of an amount of energy consumed, an amount of energy saved, an amount of money spent, an amount of money saved, an amount of pollution output, and an amount of pollution reduced is calculated from statistics generated from historical usage of the at least one application and the at least one system.

18. The apparatus of claim 14, wherein the at least one of an amount of energy consumed, an amount of energy saved, an amount of money spent, an amount of money saved, an amount of pollution output, and an amount of pollution reduced is calculated from real-time variables associated with the at least one application and the at least one system.
